(19) United States
(12) Patent Application Publication
(10) Pub. No.: US 2013/0033148 A1
(43) Pub. Date: Feb. 7, 2013

(54) ELECTRIC MACHINE

(71) Applicants: Marcel Vetter, Zuerich (CH); Claude Stalder, Gossau (CH); Roger Suter, Zuerich (CH); George Kleynhans, Buelach (CH)

(72) Inventors: Marcel Vetter, Zuerich (CH); Claude Stalder, Gossau (CH); Roger Suter, Zuerich (CH); George Kleynhans, Buelach (CH)

(73) Assignee: MAN Diesel & Turbo SE, Augsburg (DE)

(21) Appl. No.: 13/505,792

(22) PCT Filed: Sep. 7, 2010
(86) PCT No.: PCT/DE2010/050069

§ 371 Date: Jun. 21, 2012

(30) Foreign Application Priority Data
Nov. 6, 2009 (DE) 10 2009 046 482.4

(51) Int. Cl. H02K 1/18

(52) U.S. Cl. 310/216.113

(57) ABSTRACT

An electric machine has a housing with an inner circumference; a stator which is inserted into the housing so that an outer circumference of the stator is located opposite the inner circumference of the housing, a clearance fit being formed between the inner circumference of the housing and the outer circumference of the stator; at least one fastening element, each fastening element connects the stator to the housing by positive engagement so that the stator is held at the housing so as to be fixed with respect to rotation relative to it; and a rotor which is rotatably mounted in the housing in a radial direction of the electric machine inwardly of the stator.

### PRIORITY CLAIM

This is a U.S. national stage of application No. PCT/DE2010/050069, filed on Sep. 7, 2010. Priority is claimed on the following application(s): Country: Germany, Application No. 10 2009 046 482.4, filed: Nov. 6, 2009 the content of which is incorporated herein by reference in its entirety.

### FIELD OF THE INVENTION

The present invention is directed to an electric machine having a housing, a stator which is fitted into the housing so as to be fixed with respect to rotation relative to it, and a rotor which is rotatably mounted in the housing.

### BACKGROUND OF THE INVENTION

Electric machines of the kind mentioned above are known from the prior art as rotationally operating electric motors or electric generators.

The stator of an electric motor or electric generator of this kind is generally constructed of thin round plates which are stacked one upon the other as is described, for example, in U.S. Pat. No. 6,935,011 which is incorporated herein by reference in its entirety.

According to the prior art, the stator is fitted into the housing in such a way that an outer circumference of the stator is situated opposite an inner circumference of the housing, an interference fit being formed between the inner circumference of the housing and the outer circumference of the stator as is described, for example, in DE 203 17 814 U1 which is incorporated herein by reference in its entirety. In this way, the stator is held in the housing so as to be fixed with respect to displacement.

Stator and housing are assembled in the prior art in that the housing is first heated and the stator is then inserted into the housing so that the interference fit is formed between housing and stator after cooling.

However, electric motors and electric generators constructed in this way have some drawbacks. When the electric machine is stopped, the housing constantly subjects the stator to pressure in radial direction of the electric machine. Due to the radial pressure, the plates of the stator bulge in axial direction and gases can be stored therein during operation.

Since the stator tends to expand in axial as well as radial direction due to the heating occurring in operation, the stator subjects the housing to tension through expansion of the stator in radial direction and generates tensile loads in the housing which act in circumferential direction of the electric machine. If the electric machine is used, for example, to drive a compressor, high temperatures can occur due to the compression of the medium in the compressor which in turn additionally heat the stator and further increase the expansion thereof in radial and axial direction and accordingly further increase the tensile load on the housing. Further, high internal pressures can occur in the housing during operation of the electric machine which additionally subject the housing to tensile loading. Finally, the housing must accordingly be constructed sufficiently solidly to withstand the occurring tensile loads.

As a result of the expansion when the electric machine is started up and the contraction when shutting down, the position of the stator in the housing changes from an initial position or desired position of the stator. Further, in the event of damage to the stator a great effort must be made to exchange it.

It is thus an object of the present invention to provide an electric machine in which assembly and disassembly of the stator and housing is simplified and can therefore be accomplished more quickly and in which the position of the stator in the housing does not change from the initial position of the stator for operation-related reasons.

### SUMMARY OF THE INVENTION

According to the present invention, an electric machine has a housing having an inner circumference, a stator which is inserted into the housing so that an outer circumference of the stator is located opposite the inner circumference of the housing, a clearance fit being formed between the inner circumference of the housing and the outer circumference of the stator, at least one fastening element, each fastening element connecting the stator to the housing by positive engagement so that the stator is held at the housing so as to be fixed with respect to rotation relative to it, and a rotor which is rotatably mounted in the housing in a radial direction of the electric machine inwardly of the stator.

A clearance fit within the meaning of the present invention is, first, a fit between the housing and the stator, wherein both parts have the same nominal dimension but have different tolerance ranges such that a smallest inner dimension of the inner circumference of the housing is always greater than a largest outer dimension of the outer circumference of the stator. However, by clearance fit is also meant within the meaning of the present invention a fit between the housing and the stator, wherein the inner circumference of the housing has a greater nominal dimension than the outer circumference of the stator.

Owing to the clearance fit which is provided according to the invention between the inner circumference of the housing and the outer circumference of the stator, the stator can be mounted in the housing and removed from the housing without heating the housing.

Accordingly, assembly and disassembly of the stator and the housing is facilitated and can accordingly be carried out faster. Further, the housing is not subjected to tensile loading when the electric machine is stopped. Moreover, the stator, particularly the plates thereof, are not subjected to compressive loading radially so that a deformation of the stator in axial direction of the electric machine is prevented.

By means of the at least one fastening element which is provided according to the invention, the stator is fixed in position relative to the housing by positive engagement so that the position of the stator in the housing cannot change from the initial position of the stator for operation-related reasons.

The electric machine is preferably constructed as a rotationally operating electric motor or as a rotationally operating electric generator.

According to an embodiment of the invention, each fastening element extends in radial direction in such a way that it bridges an intermediate space defined between the housing and stator by the clearance fit.

In this embodiment, the fastening element engages to a certain extent on one side thereof radially in one of either the housing or the stator, and the fastening element is connected on the other side thereof to the other one of either the housing or the stator so as to be fixed with respect to position.

For example, the fastening element could be a radial projection which is formed integral with the outer circumference of the stator and which engages in a groove in the inner circumference of the housing, which groove extends axially with respect to the housing. In this way, the stator would be fixed so as to prevent rotation (i.e., fixed with respect to rotation relative to the housing). A displacement of the stator in axial direction could be prevented, e.g., by an end shield axially covering the groove or by a cover ring having the same function.

Naturally, according to the invention, the fastening element can also be formed separate from the stator and housing and connected or coupled, respectively, to both by positive engagement. In this case, each fastening element preferably extends through the housing and through the stator. In this way, a positively engaging connection is provided between the housing and the stator which can be produced quickly and disconnected quickly in a simple manner.

According to another embodiment of the invention, a plurality of fastening elements are provided, and the fastening elements are arranged at a circumferential distance from one another in a circumferential direction of the electric machine.

Because of the circumferential distribution of a plurality of fastening elements, the holding force transmitted into the housing from the stator can be well distributed so that the stress per connection point is reduced and is relatively low. Accordingly, the respective connection points or housing wall and fastening elements can have less robust dimensions so as to economize on weight and costs.

According to yet another embodiment of the invention, the fastening elements are arranged along a common circumferential line extending in circumferential direction of the electric machine. The circumferential line is preferably located in an axial center of the electric machine.

Through the arrangement of the fastening elements in the axial center, these fastening elements are exposed only to minimal elongation in axial direction because the elongations occur substantially to the left and right of the axial center and the fastening elements are accordingly located in a kind of neutral zone.

According to another embodiment of the invention, a through-opening extending from an outer circumference of the housing toward the inner circumference thereof and a threaded opening aligned with the through-opening in the outer circumference of the stator are provided for every fastening element in the housing, and every fastening element is formed by a threaded screw which is inserted through the through-opening and screwed into the threaded opening.

Because the fastening elements are realized as threaded screws, mounting and dismounting of the stator in and from the housing can be carried out particularly easily and quickly by means of a standard tool. The screw heads of the threaded screws are preferably received in counterbores (through-openings) in the housing so that the threaded screws do not mar the exterior of the electric machine.

Finally, according to the invention, the construction between the outer surface of the stator and the inner surface of the housing is a clearance fit so that assembly thereof is realized in a simple manner. The clearance fit makes it possible to prevent stressing of the structural component parts when the machine is stopped. According to an embodiment of the invention, the stator and the housing are fastened radially by screws. These fastenings fix the initial position of the stator. The elongation has no influence on the initial position when starting and shutting down the machine. In operation, the housing undergoes only a slight tensile loading in addition to the high internal pressures which may possibly occur. In the event of damage to the stator, the stator may be exchanged without great effort.

### BRIEF DESCRIPTION OF THE DRAWINGS

The invention will be described in more detail in the following with reference to a preferred embodiment and the accompanying drawings in which:

FIG. 1 is a schematic side view of the stator of an electric machine according to an embodiment of the present invention;

FIG. 2 is a schematic side view of the housing of an electric machine according to an embodiment of the present invention; and

FIG. 3 is a schematic side view of an electric machine according to an embodiment of the present invention.

### DETAILED DESCRIPTION OF THE PRESENTLY PREFERRED EMBODIMENTS

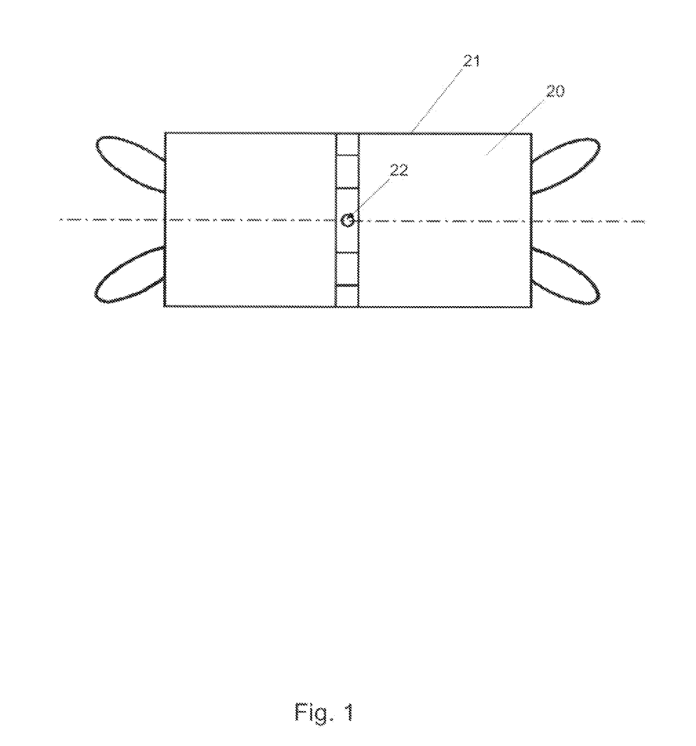

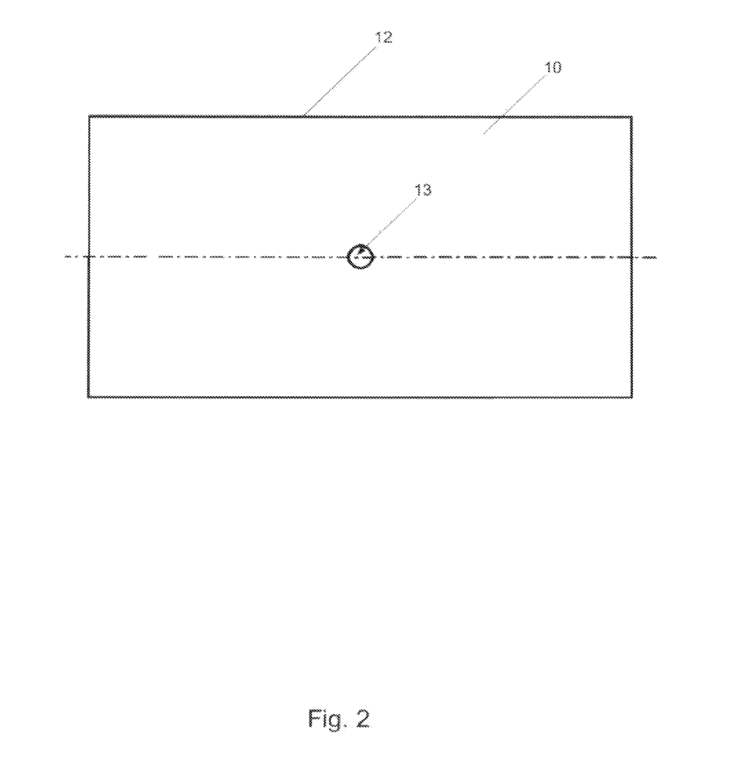

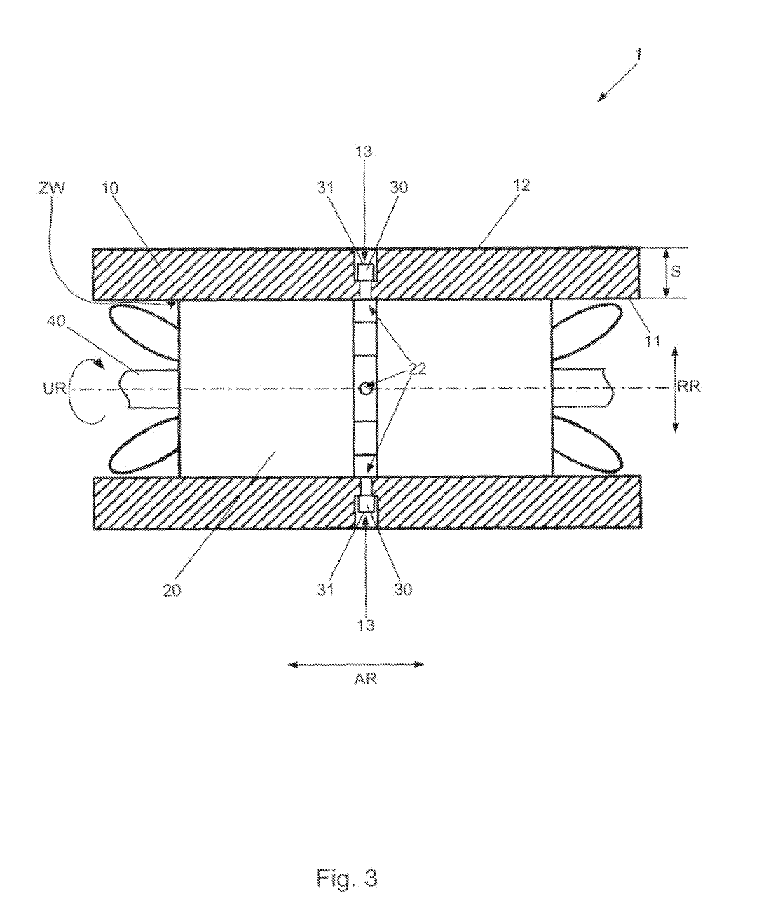

As is shown in FIGS. 1 to 3, an electric machine 1 according to an embodiment of the invention has a housing 10 with an inner circumference 11, a stator 20 which is inserted into the housing 10 (see FIG. 3) so that an outer circumference 21 of the stator 20 is located opposite the inner circumference 11 of the housing 10, and a rotor 40 which is rotatably mounted in the housing 10 in a radial direction RR of the electric machine 1 inwardly of the stator 20.

The electric machine 1 is constructed as a rotationally operating electric motor or as a rotationally operating electric generator.

A clearance fit is formed between the inner circumference 11 of the housing 10 and the outer circumference 21 of the stator 20 so that the stator 20 can be slid into and pulled out of the housing 10 easily and quickly during assembly and disassembly of the electric machine 1.

Further, the clearance fit prevents the stator 20 from being subjected to compressive loading by the housing 10 from the radially outer side. This prevents bulging of the stacked plates (not shown in detail) of the stator 20.

Further, the clearance fit allows the stator 20 sufficient radial expansion room in the event of heating of the stator 20 occurring during operation so that tensile loading of the housing 10 based on thermal expansion is prevented.

Finally, because of the reduced tensile loading, the wall thickness S of the housing 10 can be constructed so as to be appreciably thinner and therefore lighter and more economical compared to designs of the prior art.

Further, the electric machine 1 has a plurality of fastening elements 30 in the form of threaded screws. A through-opening 13 in the form of a counterbore extending from an outer circumference 12 of the housing 10 toward the inner circumference 11 thereof and a threaded opening 22 in the form of a threaded bore hole (only one threaded opening 22 can be seen in the side perspectives shown in FIGS. 1 to 3) which is aligned (in the assembled state) with the through-opening 13 in the outer circumference 21 of the stator 20 are provided for every fastening element 30 in the housing 10.

The fastening elements 30 are inserted through the respective through-openings 13 by their respective threaded shank (not shown) and sit upon a step formed in the counterbore of the respective through-opening 13 by their respective screw head 31. The threaded shank of every fastening element 30 is screwed into the corresponding threaded opening 22 in the stator 20.

In other words, each fastening element 30 extends in radial direction RR in such a way that it bridges an intermediate space ZW defined between the housing 10 and stator 20 by the clearance fit. Each fastening element 30 extends through both housing 10 and stator 20.

In this way, each fastening element 30 connects the stator 20 to the housing 10 by positive engagement so that the stator 20 is held at the housing 10 so as to be fixed with respect to rotation and axial displacement relative to it. The fastening elements 30 are preferably tightened with enough tightening torque that they remain tightened even when the stator 20 expands as a result of heat.

Accordingly, with the fastening elements 30 provided according to the invention, the stator 20 can be fixed in the housing 10 and dismounted or disconnected from the latter again easily and quickly using a standard tool.

As can be seen from FIGS. 1 to 3, the fastening elements 30 are arranged in a circumferential direction UR of the electric machine 1 at a circumferential distance (in this case, e.g., 90 degrees) from one another and along a common circumferential line extending in circumferential direction UR of the electric machine 1. The circumferential line is located in an axial center of the electric machine 1.

By means of the arrangement of the fastening elements 30 in the axial center, these fastening elements 30 are exposed only to minimal elongations in axial direction AR of the electric machine 1, since these elongations occur substantially to the left and right of the axial center, and the fastening elements 30 are accordingly located to a certain extent in a neutral zone.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-7. (canceled)

8. An electric machine comprising:
a housing (10) having an inner circumference (11);
a stator (20) having an outer circumference (21);
said stator (20) being disposed within said housing (10) so that said outer circumference (21) of said stator (20) is located opposite said inner circumference (11) of said housing (10) forming a clearance fit between said outer circumference (21) of said stator (20) and said inner circumference (11) of said housing (10);
at least one fastening element (30) connecting said stator (20) to said housing (10) by positive engagement so that said stator (20) is held at said housing (10) so as to be fixed with respect to rotation relative to said housing; and
a rotor (40) rotatably mounted in said housing in a radial direction (RR) of said electric machine inwardly of said stator (20).

9. The electric machine (1) according to claim 8, wherein each fastening element (30) extends in radial direction (RR) so as to bridge an intermediate space (ZW) defined between said housing (10) and said stator (20) by the clearance fit.

10. The electric machine (1) according to claim 8, wherein each fastening element (30) extends through said housing (10) and through said stator (20).

11. The electric machine (1) according to claim 8, comprising a plurality of said fastening elements (30) and wherein said fastening elements (30) are arranged at a circumferential distance from one another in a circumferential direction (UR) of said electric machine (1).

12. The electric machine (1) according to claim 11, wherein said fastening elements (30) are arranged along a common circumferential line extending in circumferential direction (UR) of said electric machine (1).

13. The electric machine (1) according to claim 11, wherein said circumferential line is located in an axial center of said electric machine (1).

14. The electric machine (1) according to claim 8, wherein said housing comprises an outer circumference (12) and a through-opening (13) extending from said outer circumference (12) of said housing toward said inner circumference (11); said machine further comprising a threaded opening (22) for each of said fastening elements (30), said threaded opening (22) aligned with said through-opening (13) in said outer circumference of said stator (20); each said fastening element (30) formed by a threaded screw inserted through said through-opening (13) and screwed into said threaded opening (22).

15. The electric machine (1) according to claim 9, wherein each fastening element (30) extends through said housing (10) and through said stator (20).

16. The electric machine (1) according to claim 9, wherein said housing comprises an outer circumference (12) and a through-opening (13) extending from said outer circumference (12) of said housing toward said inner circumference (11); said machine further comprising a threaded opening (22) for each of said fastening elements (30), said threaded opening (22) aligned with said through-opening (13) in said outer circumference of said stator (20); each said fastening element (30) formed by a threaded screw inserted through said through-opening (13) and screwed into said threaded opening (22).

17. The electric machine (1) according to claim 10, wherein said housing comprises an outer circumference (12) and a through-opening (13) extending from said outer circumference (12) of said housing toward said inner circumference (11); said machine further comprising a threaded opening (22) for each of said fastening elements (30), said threaded opening (22) aligned with said through-opening (13) in said outer circumference of said stator (20); each said fastening element (30) formed by a threaded screw inserted through said through-opening (13) and screwed into said threaded opening (22).

18. The electric machine (1) according to claim 11, wherein said housing comprises an outer circumference (12) and a through-opening (13) extending from said outer circumference (12) of said housing toward said inner circumference (11); said machine further comprising a threaded opening (22) for each of said fastening elements (30), said threaded opening (22) aligned with said through-opening (13) in said outer circumference of said stator (20); each said fastening element (30) formed by a threaded screw inserted through said through-opening (13) and screwed into said threaded opening (22).

19. The electric machine (1) according to claim 12, wherein said housing comprises an outer circumference (12) and a through-opening (13) extending from said outer circumference (12) of said housing toward said inner circumference (11); said machine further comprising a threaded opening (22) for each of said fastening elements (30), said threaded opening (22) aligned with said through-opening (13) in said outer circumference of said stator (20); each said fastening element (30) formed by a threaded screw inserted through said through-opening (13) and screwed into said threaded opening (22).

20. The electric machine (1) according to claim 13, wherein said housing comprises an outer circumference (12) and a through-opening (13) extending from said outer circumference (12) of said housing toward said inner circumference (11); said machine further comprising a threaded opening (22) for each of said fastening elements (30), said threaded opening (22) aligned with said through-opening (13) in said outer circumference of said stator (20); each said fastening element (30) formed by a threaded screw inserted through said through-opening (13) and screwed into said threaded opening (22).
